(19) United States
(12) Patent Application Publication
(10) Pub. No.: US 2004/0144874 A1
(43) Pub. Date: Jul. 29, 2004

(54) Method and apparatus for making high purity silica powder by ball milling

(76) Inventor: Joel P. Moskowitz, Corona Del Mar, CA (US)

Correspondence Address: LEONARD TACHNER, A PROFESSIONAL LAW CORPORATION, SUITE 38-E, 17961 SKY PARK CIRCLE, IRVINE, CA, 92614-6364, US

(21) Appl. No.: 10/351,035

(22) Filed: Jan. 24, 2003

(51) Int. Cl. B02C 17/22

(52) U.S. Cl. 241/30; 241/182

(57) ABSTRACT

A method and apparatus for making highly pure silica powder by milling the substantially pure SiO₂ charge in a ball mill which is made with an interior lining of contiguous silicon nitride plates or tiles and which employs silicon nitride media. The silicon nitride plates and media prevent contamination of the silica charge while minimizing their deterioration. The resulting slip (wet milling) or mix (dry milling) is of a higher purity because there are no substantial impurities contributed by the mill liner material or by the media.

### BACKGROUND OF THE INVENTION

1. Field of the Invention

The present invention relates generally to the field of ceramics and more particularly to a method and apparatus for ball milling silica powder with little or no contamination from exposed impurities.

2. Background Art

Desired particle size distribution usually cannot be achieved simply by screening, classifying, or elutriating a raw material. Typically, a particle size reduction (commutation) step is required. Ball milling is one of the most widely used. Ball milling consists of placing particles to be ground (the “charge”) in a closed cylindrical container with grinding media (balls, short cylinders or rods) and rotating the cylinder horizontally on its axis so that the media cascade. The ceramic particles move between the much larger media and between the media and the wall of the mill and are effectively broken into successively smaller particles.

The rate of milling is determined by the relative size, specific gravity, and hardness of the media and the particles. High-specific-gravity media can accomplish a specified size reduction much more quickly than can low-specific-gravity media.

Contamination is a problem in milling. While the particle size is being decreased, the mill walls and media are also wearing. Milling Al₂O₃ powder with porcelain or SiO₂ media can result in about 0.1% contamination per hour. Some Si₃N₄ powder milled in a porcelain-lined mill with porcelain cylinders picked up nearly 6% contamination in 72 hr. of milling time. The contamination in the Si₃N₄ resulted in a decrease in the high-temperature strength by a factor of 3 and nearly an order-of-magnitude decrease in creep resistance in the final part.

Contamination can be controlled by careful selection of the mill lining and the media. Polyurethane and various types of rubber are excellent wear-resistant linings and have been used successfully with dry milling and with water as a milling fluid. However, some milling is conducted with organic fluids that may attack rubber or polyurethane. Very hard grinding media can reduce contamination because they wear more slowly. WC is good for some cases because its high hardness reduces wear and its high specific gravity minimizes milling time. If contamination from the media is an especially critical consideration, milling can be conducted with media made of the same composition as the powder being milled.

Milling can be conducted either dry or wet. Dry milling has the advantage that the resulting powder does not have to be separated from a liquid. The major concern in dry milling is that the powder does not pack in the comers of the mill and avoids milling. The powder must be kept free flowing. One method of accomplishing this is to use a dry lubricant such as a stearate. In some cases, humidity or moisture in the powder causes packing. This has been resolved through the use of a heated mill.

Wet milling is usually very efficient if the correct ratio of fluid to powder to milling media is used. The ratio varies for different materials and usually has to be optimized experimentally. A slurry of the consistency of syrup or slightly thicker, mills effectively.

As previously noted, grinding media are the balls or cylinders that are tumbled in a ball mill to achieve particle size reduction of the powder being milled. Size reduction is achieved as the particles are pinched between adjacent balls and against the mill wall. Grinding action is enhanced by increase in specific gravity of the media and contamination is minimized by increase in hardness. The selection of media depends on a compromise between grinding time and efficiency and allowable contamination. Contamination can be minimized by using media of the same composition as the powder.

### SUMMARY OF THE INVENTION

The present invention comprises a method and apparatus for making highly pure silica powder by milling the substantially pure SiO₂ charge in a ball mill which is made with an interior lining of contiguous silicon nitride plates or tiles and which employs silicon nitride media. The silicon nitride plates and media prevent contamination of the silica charge while minimizing their deterioration. The resulting slip (wet milling) or mix (dry milling) is of a higher purity because there are no substantial impurities contributed by the mill liner material or by the media. The purer, reduced particle size silica results in higher performance end products which avoid the aforementioned strength decrease at high temperatures and creep resistance in prior art milled silica.

### BRIEF DESCRIPTION OF THE DRAWINGS

The aforementioned objects and advantages of the present invention, as well as additional objects and advantages thereof, will be more fully understood hereinafter as a result of a detailed description of a preferred embodiment when taken in conjunction with the following drawings in which:

FIG. 1 is a three-dimensional exterior view of a ball mill in accordance with a preferred embodiment of the invention;

FIG. 2 is a cross-sectional view taken along lines 2-2 of FIG. 1;

FIG. 3 is an exploded cross-sectional view of the ball mill of FIGS. 1 and 2;

FIG. 4 is an enlarged view of the encircled area shown in FIG. 3;

FIG. 5 is a cross-sectional view along lines 5-5 of FIG. 4; and

FIG. 6 is an enlarged cross-sectional view of the Si₃N₄ lining tile identified in FIG.5.

### DETAILED DESCRIPTION OF A PREFERRED EMBODIMENT

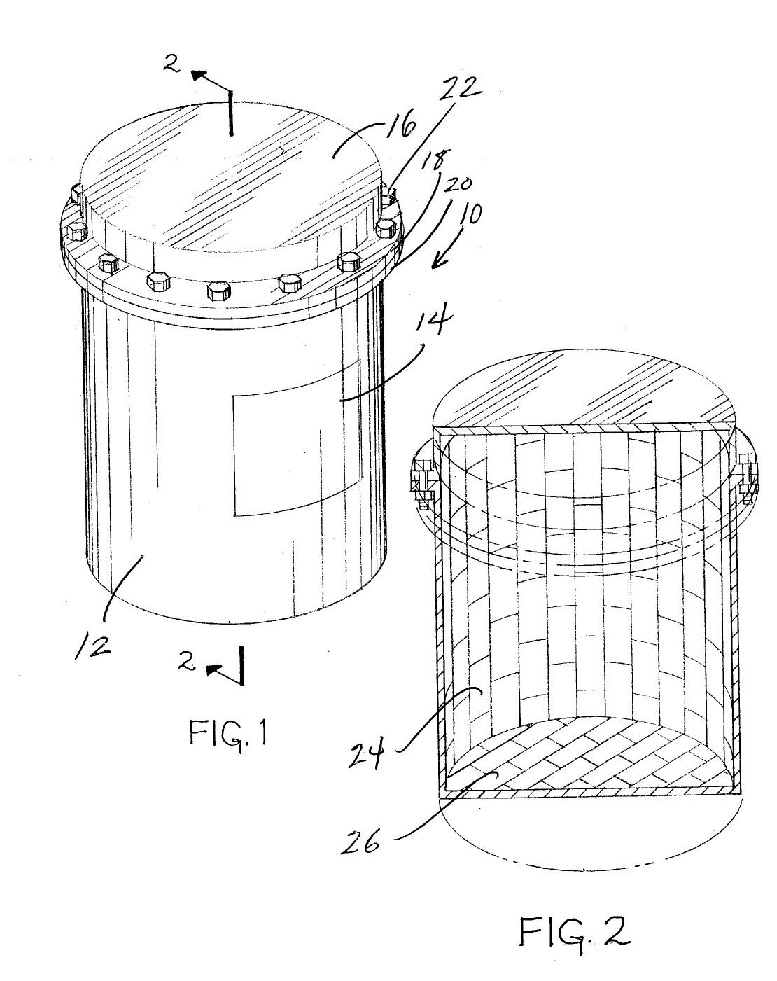

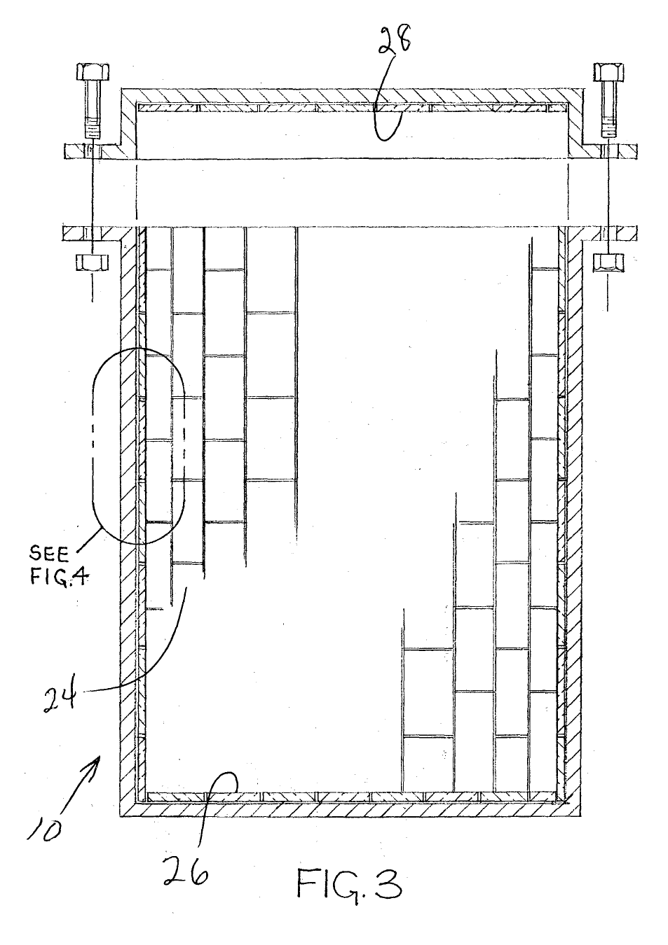

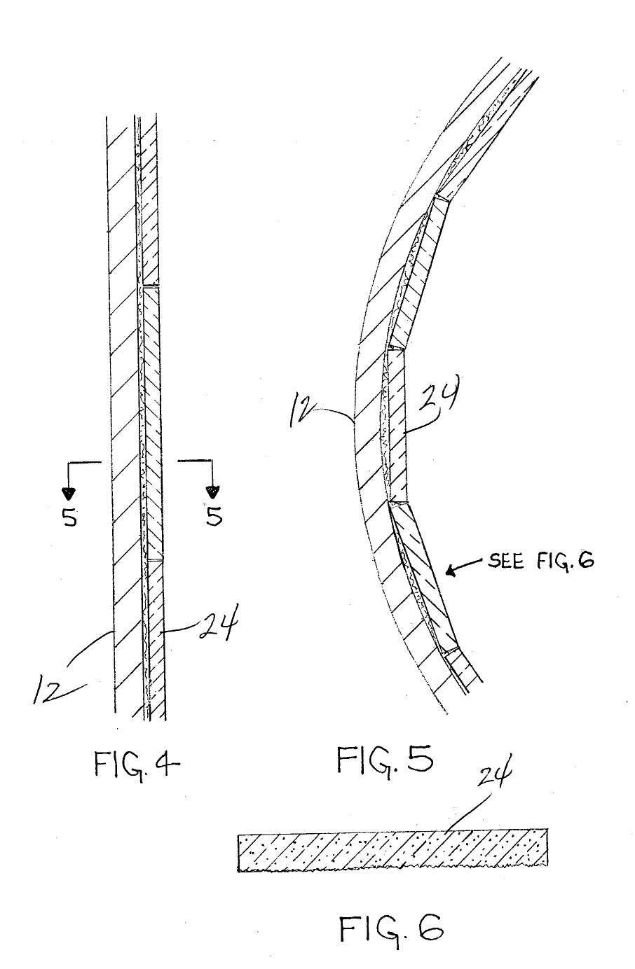

The principal feature of the present invention, the purity of the milled powder, is derived from a ball mill, a preferred embodiment of which is illustrated in the accompanying figures. As shown in FIGS. 1-6, a ball mill 10 comprises a cylinder 12 having an end wall 15, an end member 16 and an access door 14. The end member 16 is joined to the cylinder 12 by respective flanges 18 and 20 and bolts 22. The interior of the ball mill 10 is lined entirely by Si₃N₄ plates or tiles. Tiles 24 cover the interior of radial wall 12. Tiles 26 cover the interior of end wall 15 and tiles 28 cover the interior of end member 16.

Each of the tiles (24, 26, 28) is etched to fit using muriatic acid. A thin layer of bonding material, such as Macnobond 6163 from Magnolia Plastics is spread over the inside surface of the tile. Each tile is then fitted to the interior wall to provide a complete surface covering as an interior liner of contiguous silicon nitride tiles covering all of the metal surface of the ball mill interior. The bonding agent is allowed to cure completely before the mill is used.

Silicon nitride media is then loaded into the mill in standard ball mill charge quantities to ensure proper grain size reduction and mixing of the Si₃N₄ powder. The media is preferably of round or smooth rod shape. Each radial wall plate is planar or shaped with wall curvature depending on the radius of the mill and the number of tiles.

The ball mill shown in the accompanying figures has been used on two samples for milling silica and has been found to be extremely effective in producing smaller grain powder with virtually no impurities. Both samples had less than 40 parts per million of Aluminum and less than 35 parts per million of all other metals in the resulting milled powder.

Having thus described a preferred embodiment of the invention, it will now be understood that the scope hereof is limited only by the appended claims and their equivalents.

I claim:

1. A ball mill for reducing grain size of silica powder resulting from the interaction of the powder with a milling media and the interior of the mill; the ball mill comprising:
a cylinder container having interior radial and end surfaces, each of said surfaces being entirely covered with a liner, said liner being made entirely of silicon nitride.

2. The ball mill recited in claim 1 wherein said liner comprises a plurality of contiguous tiles made of Si₃N₄.

3. The ball mill recited in claim 2 wherein said tiles covering the interior radial wall of said cylindrical container are shaped to substantially conform to the shape of said radial wall.

4. The ball mill recited in claim 2 wherein each of said tiles is adhered to said interior surface by a bonding material.

5. The ball mill recited in claim 2 wherein each of said tiles is etched by an acid to a desired shape and dimension.

6. The ball mill recited in claim 5 wherein said acid is muriatic acid.

7. A method for ball milling silica powder with substantially no impurities contaminating the powder during the milling process: the method comprising the steps of:
providing a standard ball mill;
covering the entire interior of the ball mill with a silicon nitride liner; and
employing a silicon nitride milling media in said lined ball mill with a charge of powder.

8. The method recited in claim 7 wherein said covering step comprises the steps of:
preparing a plurality of silicon nitride tiles of selected size and shape; and
bonding said tiles to the interior surfaces of said ball mill in a contiguous relation.

9. The method recited in claim 8 wherein said preparing step comprises the step of etching each of said silicon nitride tiles with an acid.
